(19) United States
(12) Patent Application Publication
(10) Pub. No.: US 2013/0307798 A1
(43) Pub. Date: Nov. 21, 2013

(54) Planar Touch Panel with Single Substrate

(71) Applicant: WISTRON CORPORATION, New Taipei City (TW)

(72) Inventors: Kuei-Ching Wang, New Taipei City (TW); Ta-Hu Lin, New Taipei City (TW); Chih-Ming Hsu, New Taipei City (TW)

(73) Assignee: WISTRON CORPORATION, New Taipei City (TW)

(21) Appl. No.: 13/894,432

(22) Filed: May 15, 2013

(30) Foreign Application Priority Data
May 15, 2012 (TW) 101117217

(51) Int. Cl. H01H 9/02

(52) U.S. Cl. CPC H01H 9/02
USPC 345/173; 200/293

(57) ABSTRACT

A planar touch panel is provided. The planar touch panel includes a substrate and a plurality of periphery structures. The substrate has a plurality of transparent conductive patterns, and each of the transparent conductive patterns has a first end and a second end. The width of the first end is smaller than the width of the second end. The periphery structures are disposed adjacent to the first ends of the transparent conductive patterns, and each of the periphery structures has a first conductive layer and a decoration layer. The first conductive layer is disposed on the substrate and extends toward the first end to cover the first end. The decoration layer is disposed on the substrate and the first conductive layer. The decoration layer extends toward the first conductive layer, and is formed with an opening hole on the first conductive layer.

### BACKGROUND OF THE INVENTION

1. Field of the Invention

The present invention relates to a touch panel, and more particularly, to a planar touch panel.

2. Description of the Prior Art

Various types of touch input devices are widely used among electronic products. For instance, a mobile phone and a tablet personal computer usually utilize a touch panel as an input interface, such that a user may perform touch operations on the touch panel to input commands, e.g. drag a finger to move a cursor or write words on the touch panel. Also, the touch panel may cooperate with a display to show virtual bottoms which may be selected by the user, so as to input characters and words.

In general, the touch panel may be a resistive, capacitive, supersonic, infrared touch panel, wherein the capacitive touch panel is mostly used. The resistive touch panel may be categorized into 4-wire, 5-wire, 6-wire and 8-wire touch panels, wherein the 4-wire touch panel is developed earlier and relative manufacturing technology is more mature to be widely used.

A touch panel may include a substrate on which a trace layer, an insulation layer and FPC (Flexible Printed Circuit board) patterns may be formed. However, the substrate is made of transparent materials, e.g. glass, but bonding materials formed on a border of the touch panel are translucent or colored, such that the substrate may not visually hide the insulation layer and the FPC patterns when the user looks at the touch panel from a side view. For improving an appearance of the touch input device, it is traditionally to include a frame on a housing to cover inner elements which are not desired to be seen by the user, i.e. the insulation layer and the FPC patterns. As a result, the housing is hard to get rid of the frame.

Therefore, how to design a planar touch panel capable of hiding border traces from being seen by users has become a topic in the industry.

### SUMMARY OF THE INVENTION

It is therefore an object of the present invention to provide a planar touch panel capable of covering up border traces from being seen by users to improve the above mentioned problems.

Further, another object of the present invention is to provide a manufacturing process for the planar touch panel, such that a substrate of the planar touch panel may have multiple functions including covering up and protecting signal traces and circuits inside the planar touch panel and/or being a touch sensor. Another object of the present invention is to provide a planar touch panel capable of easily integrating with current electronic elements.

The present invention discloses a planar touch panel including a substrate and a plurality of periphery structures. The substrate has a plurality of transparent conductive patterns, and each of the transparent conductive patterns has a first end and a second end, wherein a width of the first end is smaller than a width of the second end. The plurality of periphery structures disposed adjacent to the first end of the transparent conductive patterns, and each of the periphery structures has a first conductive layer and a decoration layer. The first conductive layer is disposed on the substrate, extends toward the first end to cover the first end, and formed with an opening hole. The decoration layer is disposed on the substrate and the first conductive layer, and extends toward the first conductive layer.

In one embodiment of the present invention, the width of the transparent conductive pattern narrows from the second end to the first end.

In one embodiment of the present invention, an edge of the decoration layer does not exceed an edge of the first conductive layer.

In one embodiment of the present invention, the transparent conductive patterns are made of ITO (indium tin oxide), and the first conductive layer is made of carbon paste.

In one embodiment of the present invention, each of the periphery structures further includes a second conductive layer disposed on the decoration layer.

In one embodiment of the present invention, part of the second conductive layer is disposed in the opening hole.

In one embodiment of the present invention, the second conductive layer is made of silver paste, copper, molybdenum or aluminum.

In one embodiment of the present invention, each of the periphery structures further includes a conductive filler disposed in the opening hole of the decoration layer.

In one embodiment of the present invention, the planar touch panel further includes a pin and a conductive adhesive for bonding the pin with one of the periphery structures.

In one embodiment of the present invention, the planar touch panel further includes a display module and an optically clear adhesive for bonding the display module, the substrate and the periphery structures.

In one embodiment of the present invention, the planar touch panel further includes a polarizer disposed on a side of the substrate opposite to the transparent conductive patterns.

In one embodiment of the present invention, the substrate is utilized as a touch sensor and a cover.

In one embodiment of the present invention, the planar touch panel further includes a second substrate, and the periphery structures are disposed between the substrate and the second substrate.

In one embodiment of the present invention, the substrate is a transparent plastic substrate, a transparent glass substrate or a PET (poly ethylene terephthalate) substrate.

In one embodiment of the present invention, the planar touch panel is an inflexible or flexible planar touch panel.

The present invention discloses another planar touch panel including a substrate and a plurality of periphery structures. The substrate has a plurality of transparent conductive patterns, and each of the transparent conductive patterns has a first end and a second end, wherein a width of the first end is smaller than a width of the second end. The plurality of periphery structures respectively disposed adjacent to the first end of the transparent conductive patterns, and each of the periphery structures has a first conductive layer and a decoration layer. The decoration layer is disposed on the substrate and extends toward the first end. The first conductive layer is disposed on the decoration layer and the first end, and extends from the first end toward the first conductive layer.

In one embodiment of the present invention, an edge of the decoration layer does not exceed an edge of the first conductive layer.

In one embodiment of the present invention, the transparent conductive patterns are made of ITO (indium tin oxide), and the first conductive layer is made of conductive polymers or ITO.

In one embodiment of the present invention, each of the periphery structure further includes a second conductive layer disposed on the decoration layer, extending toward the first conductive layer, and an edge of the second conductive layer lies within an edge of the first conductive layer, or the edge of the second conductive layer is aligned with edge of the first conductive layer.

In one embodiment of the present invention, the second conductive layer is made of silver paste, copper, molybdenum or aluminum.

In one embodiment of the present invention, the planar touch panel further includes a pin and a conductive adhesive for bonding the pin with one of the periphery structures.

In one embodiment of the present invention, the planar touch panel further includes a display module and an optically clear adhesive for bonding the display module, the substrate and the periphery structures.

In one embodiment of the present invention, the width of the transparent conductive pattern narrows from the second end to the first end.

In one embodiment of the present invention, the planar touch panel further includes a polarizer disposed on a side of the substrate opposite to the transparent conductive patterns.

In one embodiment of the present invention, the substrate is utilized as a touch sensor and a cover.

In one embodiment of the present invention, the planar touch panel further includes a second substrate, and the periphery structures are disposed between the substrate and the second substrate.

In one embodiment of the present invention, the substrate is a transparent plastic substrate, a transparent glass substrate or a PET (poly ethylene terephthalate) substrate.

In one embodiment of the present invention, the planar touch panel is an inflexible or flexible planar touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A to FIG. 1F are schematic diagrams illustrating a planar touch panel according to an embodiment of the present invention.

FIG. 2 is a schematic diagram of a planar touch panel according to another embodiment of the present invention.

FIG. 3A to FIG. 3F are schematic diagrams of a planar touch panel according to another embodiment of the present invention.

FIG. 4 is a schematic diagram of a planar touch panel according to another embodiment of the present invention.

FIG. 5A and FIG. 5B are schematic diagrams of a planar touch panel according to another embodiment of the present invention.

FIG. 6A and FIG. 6B are schematic diagrams of different planar touch panels according to another embodiments of the present invention.

### DETAILED DESCRIPTION

The following description and figures describe a planar touch panel according to preferable embodiments of the present invention, wherein same elements are denoted with same symbols.

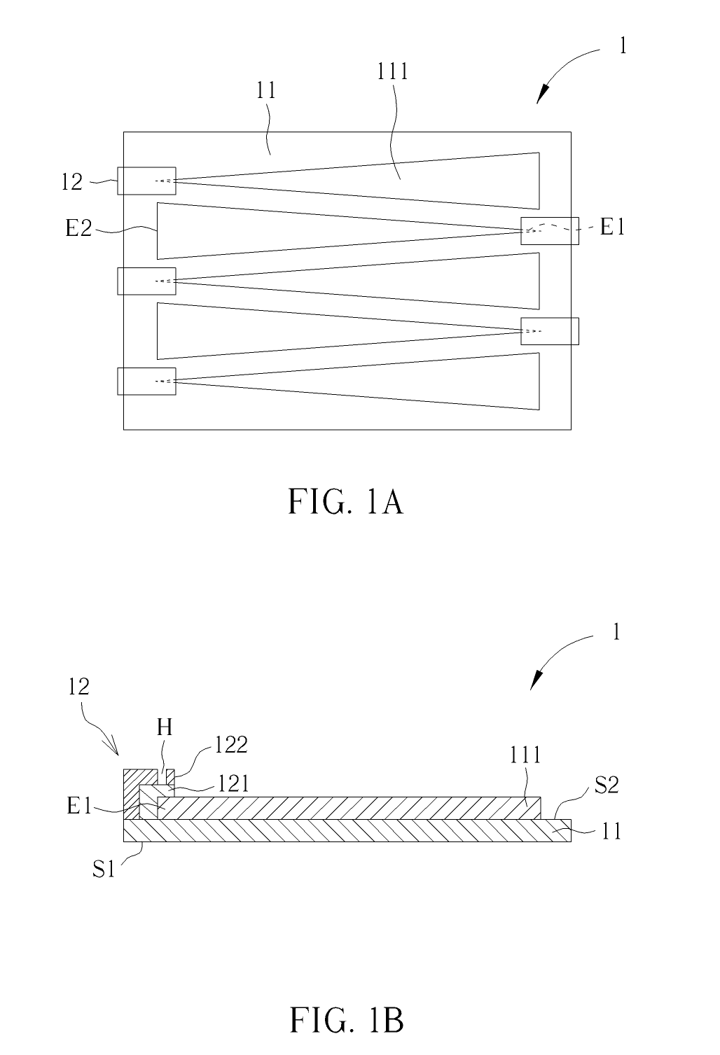

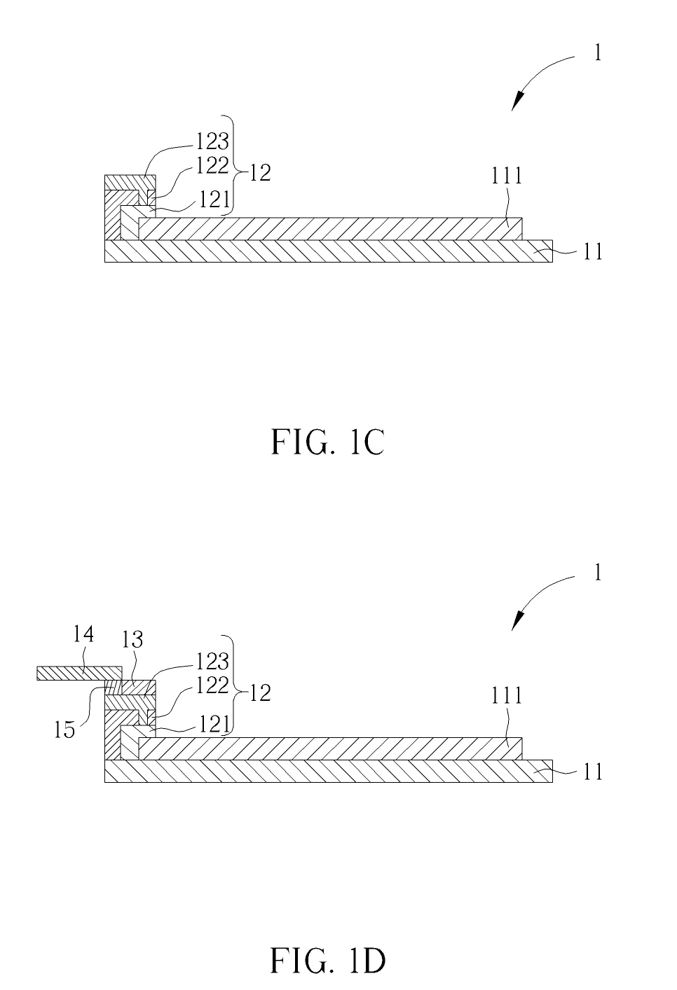

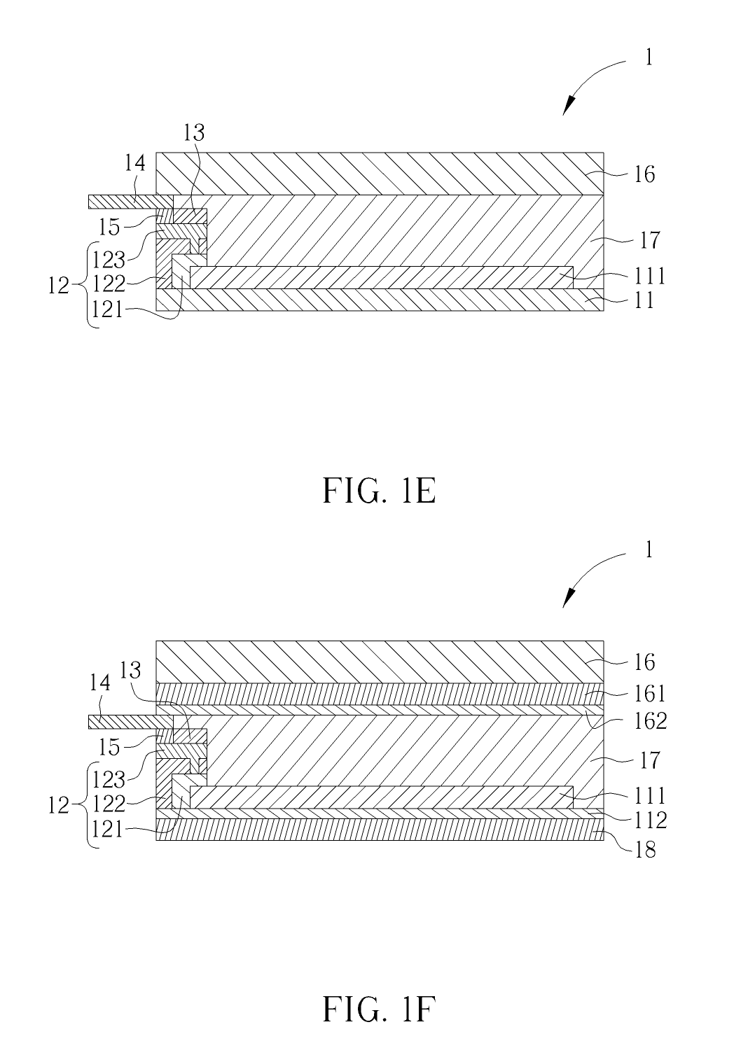

Please refer to FIG. 1A to FIG. 1F, which are schematic diagrams illustrating a planar touch panel 1 according to an embodiment of the present invention. As shown in FIG. 1A and FIG. 1B, the planar touch panel 1 includes a substrate 11 and a plurality of periphery structures 12. The planar touch panel 1 may be regarded as a planar touch panel with a single substrate. The substrate 11 may be a transparent substrate such as a transparent plastic substrate or a transparent glass substrate, or a film-liked PET (polyethylene terephthalate) substrate. A user may perform touch operations on an outer surface S1 of the substrate 11 and look into the planar touch panel 1 through the outer surface S1, elements except for the outer surface S1 comprised in the planar touch panel 1 are disposed on a side of the substrate 11 opposite to the outer surface S1, i.e. an inner surface S2.

The inner surface S2 of the substrate 11 has a plurality of transparent conductive patterns 111 to define sensing or signal traces, and the transparent conductive patterns 111 may be made of ITO (Indium Tin Oxide). Each of the transparent conductive patterns 111 has a first end E1 and a second end E2, and the two adjacent transparent conductive patterns 111 are mirror images of each other. A width of the transparent conductive patterns 111 may narrow from the second end E2 toward the first end E1, and the width at the first end E1 is smaller than the width at the second end E2.

In this embodiment, there are five transparent conductive patterns 111 shown in FIG. 1A, and the transparent conductive patterns 111 have a triangle shape for example, which are not limited. In practice, a number and a shape of the transparent conductive patterns 111 may be selected and changed according to practical requirements.

Each of the periphery structures 12 is respectively disposed adjacent to the first end E1 of the transparent conductive pattern 111, and each of the periphery structures 12 includes a first conductive layer 121 and a decoration layer 122. The first conductive layer 121 is disposed on the substrate 11 and extends toward the first end E1 of the transparent conductive pattern 111 to cover the first end E1. The decoration layer 122 is disposed on the substrate 11 and the first conductive layer 121, extends toward the first conductive layer 121, and is formed with an opening hole H. Besides, an edge of the decoration layer 122 does not exceed an edge of the first conductive layer 121. In other words, a projection of the decoration layer 122 lies within the first conductive layer 121, or the edge of the decoration layer 122 is aligned with the edge of the first conductive layer 121.

The first conductive layer 121 may be made of conductive carbon paste, and the decoration layer 122 may be made of insulate materials or colored ink. A color of the decoration layer 122 is preferably similar to a color of the first conductive layer 121, such that the user may not notice a color difference between the decoration layer 122 and first conductive layer 121 when the user looks into the planar touch panel 1 through the outer surface S1. The first conductive layer 121 and the decoration layer 122 may be formed on the substrate 11 by printing.

As shown in FIG. 1C, the periphery structure 12 includes a second conductive layer 123. The second conductive layer 123 is disposed on the decoration layer 122, and part of the second conductive layer 123 is filled in the opening hole H to electrically connect with the first conductive layer 121. The second conductive layer 123 may be made of silver paste, copper, molybdenum or aluminum. In implementation, if the second conductive layer 123 is made of silver paste, signal traces may be defined according to designed stencils to print on the decoration layer 122 by screen printing facilities. Meanwhile, if the second conductive layer 123 is made of copper, Mo (molybdenum) or Al (aluminum), copper wires or Al—Mo wires may be formed on the second conductive layer 123 by a sputtering process.

Noticeably, printing processes mentioned in the present invention are not limited and may be realized by letterpress, intaglio, lithography or screen printings. For example, the first conductive layer 121, the decoration layer 122 and the second conductive layer 123 may be formed by the printing processes as above mentioned. In addition, the silver paste coated on the second conductive layer 123 may include silver nanoparticles or other conductive metal materials such as titanium, zinc, zirconium, antimony, indium, tin, copper, molybdenum or aluminum to reach better conductivity.

Moreover, a lithography process may be combined with a screen printing process to form the second conductive layer 123. Specifically, patterns of the second conductive layer 123 may be formed by applying printing materials such as photosensitive conductive material or UV (ultraviolet) curable conductive material, so as to print on the substrate 11 by screen printing. Subsequently, part of the photosensitive conductive material or UV curable conductive material covered by a mask may be solidified in the radiation of electromagnetic wave such as UV light. Afterwards, rest of the photosensitive conductive material or UV curable conductive material which is not solidified may be washed off, and the patterns of the second conductive layer 123 may be formed. In implementation, the patterns of the second conductive layer 123 may be formed by solidifying part of the photosensitive conductive material or UV curable conductive material and washing off the rest of the photosensitive conductive material or UV curable conductive material which is not solidified.

Further, the photosensitive conductive material or UV curable conductive material may be a material which is conductive and dried and solidified in the radiation of electromagnetic wave with a short wavelength. As a result, the second conductive layer 123 may be formed with signals traces having small width and narrow distance from adjacent signal traces.

As shown in FIG. 1D, the planar touch panel 1 further includes an insulation layer 13, a pin 14 and a conductive adhesive 15. The insulation layer 13 is disposed on the second conductive layer 123, and the conductive adhesive 15 is used for bonding the pin 14 and the second conductive layer 123. In implementation, the insulation layer 13 may cover the second conductive layer 123 by screen printing, so as to protect the second conductive layer 123 from forming oxidations due to air exposure. The pin 14 may be formed by a FPCB (Flexible Printed Circuit Board), disposed adjacent to the insulation layer 13, and bonded with the second conductive layer 123 through the conductive adhesive 15. The pin 14 may be electrically connected to the first conductive layer 121 through the conductive adhesive 15 and the second conductive layer 123 to receive touch signals generated by the transparent conductive patterns 111. The conductive adhesive 15 may be an ACF (Anisotropic Conductive Film) or an ACP (Anisotropic Conductive Paste). In other embodiments, the insulation layer 13 may not be included according to practical requirements.

As shown in FIG. 1E, the planar touch panel 1 further includes a display module 16 and an optically clear adhesive 17. In implementation, the display module 16 includes a liquid display module and a polarizer. The optically clear adhesive 17 is used for bonding the display module 16, the substrate 11 and the periphery structure 12.

Therefore, in such a structure, the present invention may select the first conductive layer 121 and the decoration layer 122, all of which have similar colors, and dispose the second conductive layer 123 on the decoration layer 122, such that border signal traces formed by the first conductive layer 121, the second conductive layer 123, the conductive adhesive 15 and the pin 14 may not be aware or visually seen by the user. On the other hand, the substrate 11 of the present invention on which the transparent conductive pattern 111 is directly formed to work as a sensor as well as a cover, which may benefit for product miniaturization. In addition, the first conductive layer 121 is directly disposed on the substrate 11 and connected to the first end E1, which may reduce a risk of trace breakage due to a height of the periphery structure 12, so as to improve a reliability of signal transmission of the planar touch panel 1.

As shown in FIG. 1F, the display module 16 of the planar touch panel 1 include a polarizer 161 and an optical film 162. The polarizer 161 may be an axial polarizer, and the optical film 162 may be used for compensating a quarter wavelength of phase difference. Furthermore, an optical film 112 may be bonded at an outside of the substrate 11 of the planar touch panel 1, and the optical film 112 may be used for compensating the quarter wavelength of phase difference to cooperate with the optical film 162, such that an incident light may be switched between circularly polarized and linearly polarized. The planar touch panel 1 further includes a polarizer 18, which is preferably an axial polarizer. The polarizer 18 may be disposed on a side of the substrate 11 opposite to the transparent conductive patterns, i.e. the side on which the user performs touch operations.

In implementation, if the substrate 11 is made of PC (polycarbonate) film, and the polarizer 18, the optical film 112 for compensating the quarter wavelength of phase difference, the substrate 11, the optical film 162 and the polarizer 161 of the display module 16 are disposed in order, in such a structure, optical interference patterns generated by sunlight may be mitigated and a visibility under blazing light, e.g. sunlight, may be improved as well. Certainly, in other embodiments, the optical film 112 or the optical film 162 may be realized by a phase difference coating on the substrate 11 or the display module 16.

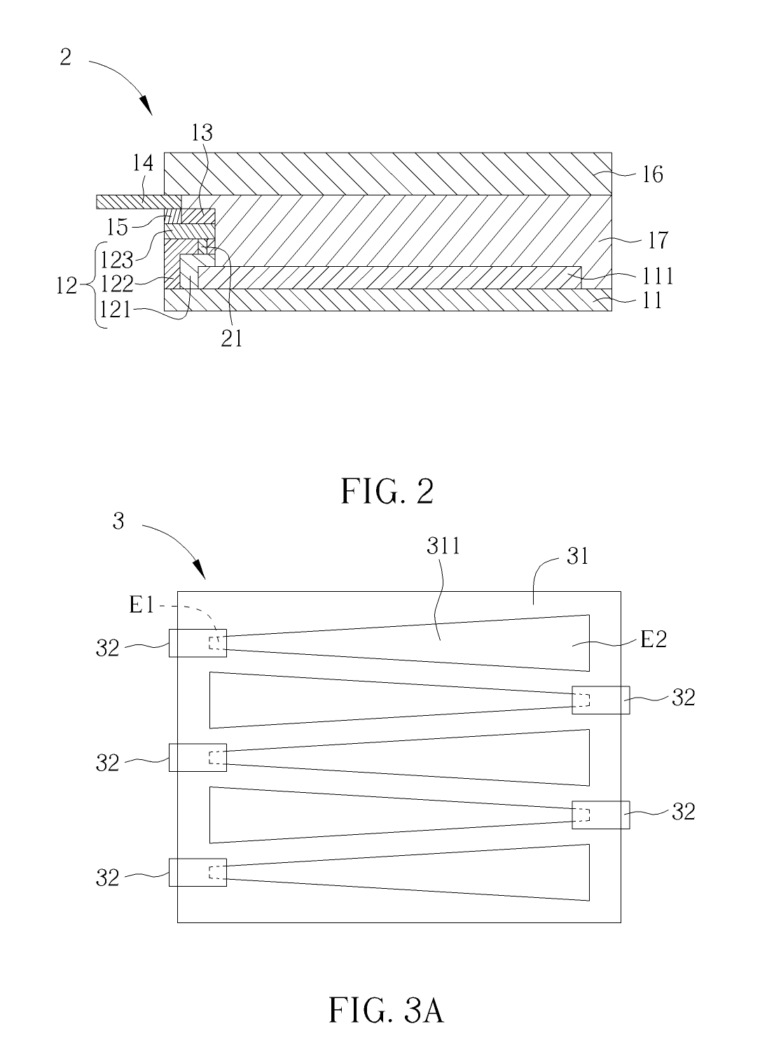

Please refer to FIG. 2, which is a schematic diagram of a planar touch panel 2 according to another embodiment of the present invention. Differences between the planar touch panel 2 and the planar touch panel 1 are that the planar touch panel 2 further includes a conductive filler 21 filled in the opening hole H shown in FIG. 1B of decoration layer 122, and the second conductive layer 123 is disposed on the decoration layer 122 and the conductive filler 21. The conductive filler 21 may be made of carbon, nano copper, nano silver, conductive polymer resin, and so on.

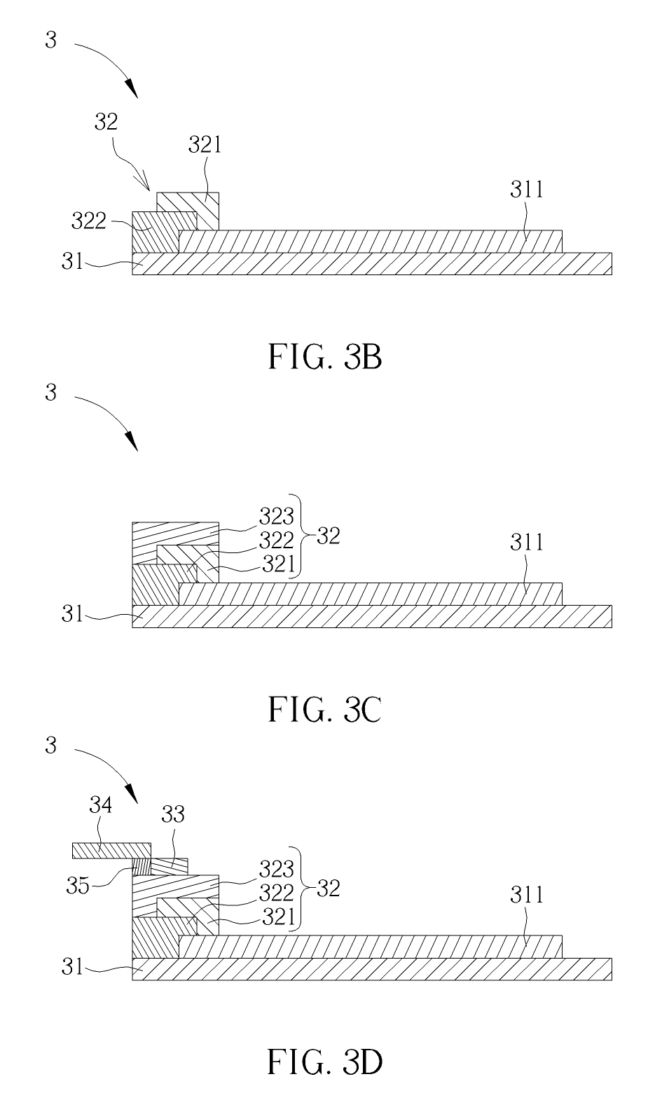

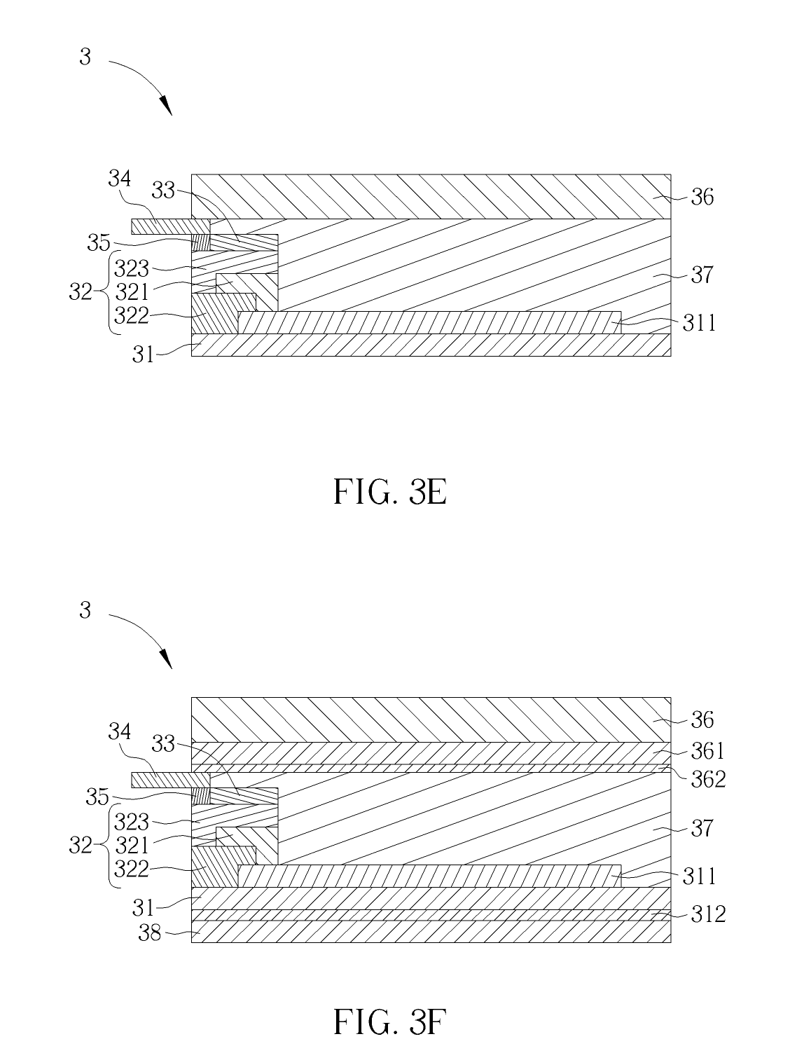

Please refer to FIG. 3A to FIG. 3F, which are schematic diagrams of a planar touch panel 3 according to an embodiment of the present invention. As shown in FIG. 3A and FIG. 3B, the planar touch panel 3 includes a substrate 31 and a plurality of periphery structures 32. The substrate 31 may be a transparent substrate such as a plastic substrate or a glass substrate. The substrate 31 includes an outer surface S1 and an inner surface S2. The user may look from the outer surface S1 into the planar touch panel 3 to perform touch operations accordingly. Other elements included in the planar touch panel 3 may be disposed at a side adjacent to the inner surface S2 of the substrate 31.

The inner surface S2 of the substrate 31 has a plurality of transparent conductive patterns 311 on which sensing or signal traces are formed, and the transparent conductive pattern 311 may be made of ITO. Each of the transparent conductive patterns 311 has a first end E1 and a second end E2. A width of the transparent conductive pattern 311 narrows from the second end E2 toward the first end E1, wherein a width of the first end E1 is smaller than a width of the second end E2. In this embodiment, there are five transparent conductive patterns 311 illustrated in FIG. 3A, and the transparent conductive patterns 311 have a trapezoidal shape for example, which are not limited.

Each of the periphery structures 32 is respectively disposed adjacent to the first end E1 of the transparent conductive pattern 311, and each of the periphery structures 32 has a first conductive layer 321 and a decoration layer 322. The decoration layer 322 may be disposed on the substrate 11 and extend toward the first end E1. The first conductive layer 321 may be disposed on the decoration layer 322 and the first end E1, and extend from the decoration layer 322 toward the first end E1 to cover beyond an edge of the transparent conductive pattern 311. The first conductive layer 321 may be made of conductive polymer materials or ITO, and formed on the substrate 11 by printing.

As shown in FIG. 3C, the planar touch panel 3 further includes a second conductive layer 323. The second conductive layer 323 may be disposed on the decoration layer 322 and the first conductive layer 321, extend toward the first conductive layer 321, and an edge of the second conductive layer 323 does not exceed an edge of the first conductive layer 321. In other words, a projection of the decoration layer 322 lies within the first conductive layer 321, or the edge of the decoration layer 322 is aligned with the edge of the first conductive layer 321. If the second conductive layer 323 is made of silver paste, signal traces may be defined according to designed stencils to print on the decoration layer 322 by screen printing facilities. Meanwhile, if the second conductive layer 323 is made of copper, Mo or Al, copper wires or Al—Mo wires may be formed on the second conductive layer 323 by the sputtering process.

As shown in FIG. 3D, the planar touch panel 3 further includes an insulation layer 33, a pin 34 and a conductive adhesive 35. The insulation layer 33 may be disposed on the second conductive layer 323, the conductive adhesive 35 is used for bonding the pin 34 with the second conductive layer 323. In implementation, the insulation layer 33 may cover on the second conductive layer 323 by screen printing, so as to protect the second conductive layer 323 from forming oxidations due to air exposure. The pin 34 may be formed by an FPC (Flexible Printed Circuit Board) and bonded on the second conductive layer 323 through the conductive adhesive 35. The pin 34 may be electrically connected to the first conductive layer 321 through the conductive adhesive 35 and the second conductive layer 323, so as to receive touch signals generated by the transparent conductive pattern 311. The conductive adhesive 35 may be an ACF (Anisotropic Conductive Film) or an ACP (Anisotropic Conductive Paste). In other embodiments, the insulation layer may not be included according to practical requirements.

As shown in FIG. 3E, the planar touch panel 3 further includes a display module 36 and an optically clear adhesive 37. In implementation, the display module 36 includes a liquid display module and a polarizer. The optically clear adhesive 37 is used for bonding the display module 36, the substrate 31 and the periphery structure 32.

Therefore, in such a structure, the present invention may dispose the decoration layer 322 on the substrate 31 and dispose the first conductive layer 321 on the decoration layer 322, such that border traces formed by the first conductive layer 321, the second conductive layer 323, the conductive adhesive 35 and the pin 34 may not be aware or visually seen by the user.

On the other hand, the substrate 31 of the present invention on which the transparent conductive pattern 311 is formed directly to operate as a touch sensor, a cover for protecting the planar touch panel 3, as well as a decorator for hiding traces and elements around the border of the touch panel 3, which may be benefit for product miniaturization.

As shown in FIG. 3F, similar to the planar touch panel 1, the planar touch panel 3 further includes polarizers 361 and 38 and optical films 362 and 312 to mitigate the optical interference patterns and improve the visibility under the blazing light. Operations and characteristics of the polarizer 361 and 38 and the optical films 362 and 312 may be obtained by referring to operations and characteristics of the polarizers 161 and 18 and the optical films 162 and 112, which are omitted.

Please note that the planar touch panel with single substrate illustrated in the embodiments on which is formed with the transparent conductive patterns, such that the substrate may operate versatilely. First, after the planar touch panel is assemble, the substrate is disposed at the outer surface to cover and hide the periphery structures, the border signal traces, the transparent conductive patterns and other elements from being visually seen be the user. Second, the substrate may protect the periphery structures, the border traces and the transparent conductive patterns from air disposure. Third, the substrate is formed with the transparent conductive patterns to be a touch sensor. As a result, the substrate of the present invention may have versatile functions and be produced by simple processes to save an assembly step that adhesive a cover onto the planar touch panel, which may be benefit for module assembly to reduce production cost. Those skilled in the art may make alterations or modifications according to above embodiments and descriptions to design and realize the planar touch panel of the present invention.

Moreover, the planar touch panel may be an inflexible planar touch panel or a flexible planar touch panel.

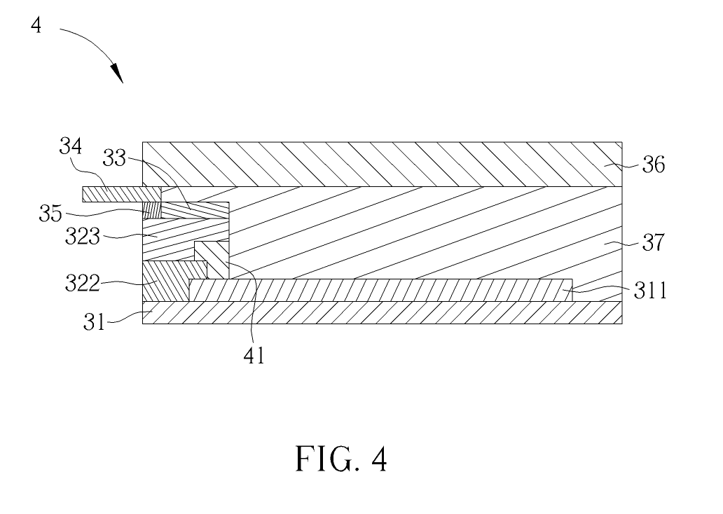

Please refer to FIG. 4, which is a schematic diagram of a planar touch panel 4 according to another embodiment of the present invention. A difference between the planar touch panel 4 and the planar touch panel 3 is that an edge of a first conductive layer 41 of the planar touch panel 4 does not exceed the edge of the transparent conductive pattern 311. In other words, a projection of the first conductive layer 41 lies within the transparent conductive pattern 311.

In such a structure and the feature that the width of the first conductive layer narrows from the second end E2 toward the first end E1, the planar touch panel of the present invention may be compatible and cooperate with a drive IC (integrated circuit) and a processor currently used to integrate with electronic elements currently used and reach a wider usage in the field.

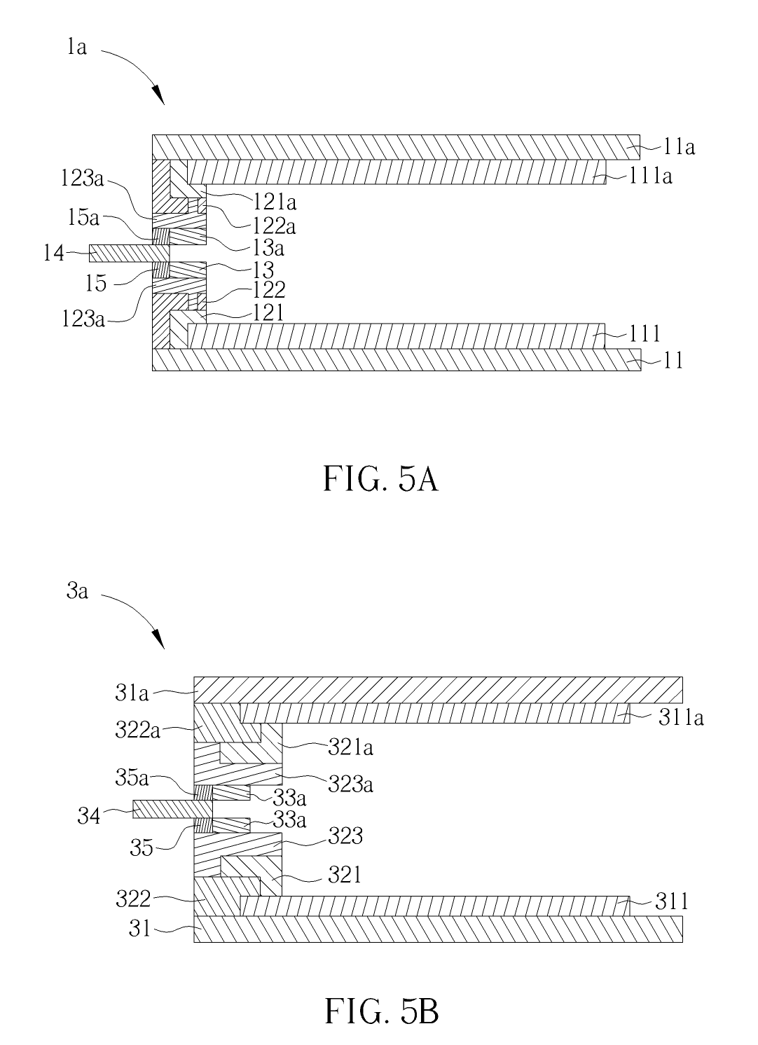

FIG. 5A and FIG. 5B are schematic diagrams of a planar touch panel 1a according to another embodiment of the present invention. Please refer to FIG. 5A, the planar touch panel 1a includes substrates 11 and 11a, the transparent conductive patterns 111 and 111a, first conductive layers 121 and 121a, decoration layers 122 and 122a, second conductive layers 123 and 123a, insulation layers 13 and 13a, the pin 14 and conductive adhesives 15 and 15a. Structures and manufacturing processes of the substrate 11a, the transparent conductive pattern 111a, the first conductive layer 121a, the decoration layer 122a, the second conductive layer 123a, the insulation layer 13a, the pin 14 and the conductive adhesive 15a may be obtained by referring to descriptions about the corresponding elements shown in FIG. 1A to FIG. 1D, which is omitted.

Please refer to FIG. 5B, the planar touch panel 3a further includes substrates 31 and 31a, transparent conductive patterns 311 and 311a, first conductive layers 321 and 321a, decoration layers 322 and 322a, second conductive layers 323 and 323a, insulation layers 33 and 33a, the pin 34 and conductive adhesives 35 and 35a. Structures and manufacturing processes of the substrate 31a, the transparent conductive pattern 311a, the first conductive layer 321a, the decoration layer 322a, the second conductive layer 323a, the insulation layer 33a, the pin 34 and conductive adhesive 35a may be obtained by referring to descriptions about the corresponding elements shown in FIG. 3A to FIG. 3D, which is omitted.

Noticeably, the above mentioned two types of the planar touch panels may be utilized in a planar touch panel with two substrates. Specifically, the planar touch panel with single substrate may include another substrate, and the periphery structures may be disposed between the two substrates, and thus the substrate closed to the user may have at least three functions of decoration, protecting the periphery structure, the border signal traces and elements, as well as sensing axial touch operation. In short, the planar touch panel of the present invention may have multiple functions.

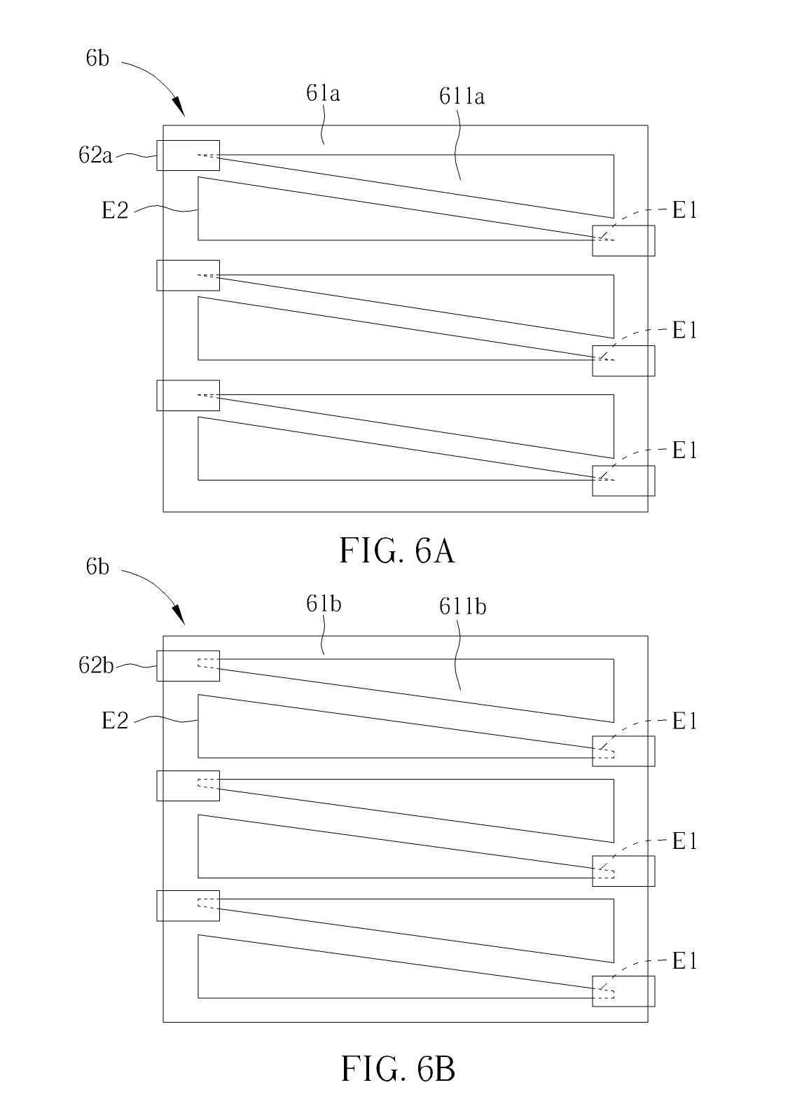

FIG. 6A and FIG. 6B are respectively schematic diagrams of planar touch panels 6a and 6b according to another embodiments of the present invention. In the two embodiments, the planar touch panels 6a and 6b are similar to above mentioned embodiments to respectively include substrates 61a and 61b, transparent conductive patterns 611a and 611b, periphery structures 62a and 62b, wherein the width of the first end E1 is smaller than the width of the second end E2. A difference between the planar touch panels 6a and 6b is that the transparent conductive pattern 611a shown in FIG. 6A has a right-triangle shape, while the transparent conductive pattern 611b shown in FIG. 6B has a trapezoidal shape. Accordingly, a shape of the transparent conductive pattern of the present invention is not limited, as long as the width of the first end is smaller than the width of the second end.

To sum up, in the planar touch panel of the present invention, the first conductive layer may be disposed on the substrate and extend toward the first end to cover the first end. The decoration layer may be disposed on the substrate and extend toward the first conductive layer. The first conductive layer may be disposed on the decoration layer and the first end, such that the decoration layer may hide the border trace from being aware or visually seen by the user.

Moreover, the planar touch panel with single substrate of the present invention may save the assembly step that adhesive a cover onto the planar touch panel, which may be benefit for product miniaturization.

What is more important and greater benefit, the substrate of the planar touch panel of the present invention may have multiple functions. First, the substrate may cover and hide the periphery structures, the border signal traces, the transparent conductive patterns and other elements. Second, the substrate may protect the periphery structures, the border traces and the transparent conductive patterns from air disposure. Third, the substrate is formed with the transparent conductive patterns to be a touch sensor. In short, the planar touch panel of the present invention may have at least three functions of decoration, protecting the periphery structure, the border signal traces and elements, as well as sensing axial touch operation.

The planar touch panel in the prior art requires the assembly step that adhesive a cover onto the planar touch panel to reach the functions of decoration and protection. In comparison, the substrate of the present invention may have multiple functions and be produced by simple processes to save the assembly step that adhesive a cover onto the planar touch panel, which may be benefit for module assembly to reduce production cost.

Furthermore, in the structure of the present invention including the feature that the width of the first conductive layer narrows from the second end toward the first end, the planar touch panel of the present invention may be compatible and cooperate with a drive IC and a processor currently used to integrate with electronic elements currently used and reach a wider usage in the field.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A planar touch panel, comprising:
a substrate having a plurality of transparent conductive patterns, and each of the transparent conductive patterns having a first end and a second end, wherein a width of the first end is smaller than a width of the second end; and
a plurality of periphery structures disposed adjacent to the first end of the transparent conductive patterns, each of the periphery structures having a first conductive layer and a decoration layer;
wherein the first conductive layer is disposed on the substrate, extends toward the first end to cover the first end, and is formed with an opening hole;
wherein the decoration layer is disposed on the substrate and the first conductive layer, and extends toward the first conductive layer.

2. The planar touch panel of claim 1, wherein the width of the transparent conductive pattern narrows from the second end to the first end.

3. The planar touch panel of claim 1, wherein an edge of the decoration layer does not exceed an edge of the first conductive layer.

4. The planar touch panel of claim 1, wherein the transparent conductive patterns are made of ITO (indium tin oxide), and the first conductive layer is made of carbon paste.

5. The planar touch panel of claim 1, wherein each of the periphery structures further comprises:
a second conductive layer disposed on the decoration layer.

6. The planar touch panel of claim 5, wherein a part of the second conductive layer is disposed in the opening hole.

7. The planar touch panel of claim 5, wherein the second conductive layer is made of silver paste, copper, molybdenum or aluminum.

8. The planar touch panel of claim 1, wherein each of the periphery structures further comprises:
a conductive filler disposed in the opening hole of the decoration layer.

9. The planar touch panel of claim 1, further comprising:
a pin; and
a conductive adhesive for bonding the pin with one of the periphery structures.

10. The planar touch panel of claim 1, further comprising:
a display module; and
an optically clear adhesive for bonding the display module, the substrate and the periphery structures.

11. The planar touch panel of claim 1, further comprising:
a polarizer disposed on a side of the substrate opposite to the transparent conductive patterns.

12. The planar touch panel of claim 1, wherein the substrate is utilized as a touch sensor and a cover.

13. The planar touch panel of claim 1, further comprising a second substrate, and the periphery structures is disposed between the substrate and the second substrate.

14. The planar touch panel of claim 1, wherein the substrate is a transparent plastic substrate, a transparent glass substrate or a PET (poly ethylene terephthalate) substrate.

15. The planar touch panel of claim 1, which is an inflexible or flexible planar touch panel.

16. A planar touch panel, comprising:
a substrate having a plurality of transparent conductive patterns, each of the transparent conductive patterns having a first end and a second end, wherein a width of the first end is smaller than a width of the second end; and
a plurality of periphery structures respectively disposed adjacent to the first end of the transparent conductive patterns, each of the periphery structures having a first conductive layer and a decoration layer;
wherein the decoration layer is disposed on the substrate and extends toward the first end;
wherein the first conductive layer is disposed on the decoration layer and the first end, and extends from the first end toward the first conductive layer.

17. The planar touch panel of claim 16, wherein an edge of the decoration layer does not exceed an edge of the first conductive layer.

18. The planar touch panel of claim 16, wherein the transparent conductive patterns are made of ITO (indium tin oxide), and the first conductive layer is made of conductive polymers or ITO.

19. The planar touch panel of claim 16, wherein each of the periphery structure further comprises:
a second conductive layer disposed on the decoration layer, and extending toward the first conductive layer, wherein an edge of the second conductive layer lies within an edge of the first conductive layer, or the edge of the second conductive layer is aligned with edge of the first conductive layer.

20. The planar touch panel of claim 16, wherein the second conductive layer is made of silver paste, copper, molybdenum or aluminum.

21. The planar touch panel of claim 16, further comprising:
a pin; and
a conductive adhesive for bonding the pin with one of the periphery structures.

22. The planar touch panel of claim 16, further comprising:
a display module; and
an optically clear adhesive for bonding the display module, the substrate and the periphery structures.

23. The planar touch panel of claim 16, wherein the width of the transparent conductive pattern narrows from the second end to the first end.

24. The planar touch panel of claim 16, further comprising:
a polarizer disposed on a side of the substrate opposite to the transparent conductive patterns.

25. The planar touch panel of claim 16, wherein the substrate is utilized as a touch sensor and a cover.

26. The planar touch panel of claim 16, further comprising a second substrate, and the periphery structures are disposed between the substrate and the second substrate.

27. The planar touch panel of claim 16, wherein the substrate is a transparent plastic substrate, a transparent glass substrate or a PET (poly ethylene terephthalate) substrate.

28. The planar touch panel of claim 16, which is an inflexible or flexible planar touch panel.
